(19) United States
(12) Patent Application Publication
(10) Pub. No.: US 2025/0023195 A1
(43) Pub. Date: Jan. 16, 2025

(54) POSITIVE ELECTRODE PLATE, BATTERY CELL, AND BATTERY

(71) Applicant: ZHUHAI COSMX BATTERY CO., LTD., Zhuhai (CN)

(72) Inventors: Junyi ZHAO, Zhuhai (CN); Fei HE, Zhuhai (CN); Suli LI, Zhuhai (CN)

(73) Assignee: ZHUHAI COSMX BATTERY CO., LTD., Zhuhai (CN)

(21) Appl. No.: 18/898,198

(22) Filed: Sep. 26, 2024

Related U.S. Application Data
(63) Continuation of application No. PCT/CN2023/121215, filed on Sep. 25, 2023.

(30) Foreign Application Priority Data
Oct. 20, 2022 (CN) 202211288844.1

(51) Int. Cl. H01M 50/474; H01M 50/486

(52) U.S. Cl. CPC H01M 50/474; H01M 50/486

(57) ABSTRACT

Disclosed are a positive electrode plate, a battery cell, and a battery. The positive electrode plate includes a current collector, an active material layer, a first and a second insulation layer, where the current collector includes a first and a second surface disposed opposite each other; first surface includes a first, a second, and a third region along a short side; and second surface includes a fourth, a fifth, and a sixth region along a short side; active material layer is disposed in second and fifth region; first insulation layer is disposed in the first, third, fourth, and sixth region; and second insulation layer is disposed on active material layer and first insulation layer. The positive and negative electrode plate have a same width, to resolve a problem of poor coverage of a positive electrode and a negative electrode, thereby greatly improving safety of a battery.

### CROSS-REFERENCE TO RELATED APPLICATIONS

The present disclosure is a continuation of International Application No. PCT/CN2023/121215, filed on Sep. 25, 2023, which claims priority to Chinese Patent Application No. 202211288844.1, filed on Oct. 20, 2022. All of the aforementioned patent applications are hereby incorporated by reference in their entireties.

### TECHNICAL FIELD

The present disclosure relates to the field of battery technologies, and specifically, to a positive electrode plate, a battery cell, and a battery.

### BACKGROUND

With the popularization of lithium-ion batteries, lithium-ion batteries have now occupied 50% to 70% of the market. In the market, a negative electrode plate of a lithium-ion battery is wider than a positive electrode plate thereof, resulting in poor coverage of a positive electrode and a negative electrode (FIG. 7B) during winding or stacking. Therefore, it is necessary to correct coverage differences of the positive electrode and the negative electrode in time. Otherwise, a positive electrode and a negative electrode of a jelly roll are flush with each other or a jelly roll is spiral due to poor coverage of the electrode plates (FIG. 8B and FIG. 8C). The jelly roll obtained in this way has defects of an excessive height, poor coverage, and the like. As a result, the jelly roll is scrapped. Poor coverage of the positive electrode plate and the negative electrode plate may lead to a problem that Li sources in a portion are sufficient while Li sources in another portion are insufficient, which results in insufficient dynamic performance of the battery. In addition, poor coverage of the positive electrode plate and the negative electrode plate may also lead to formation of a Li dendrite in a portion, easily making a separator pierced. As a result, the battery is partially short-circuited, and self-discharge of the battery becomes excessive. This greatly weakens a continuous discharge capability of the battery, and goes against long-term use of the battery. Moreover, excessive self-discharge of the battery also leads to a static voltage difference and a dynamic voltage difference of the battery. As a result, a computer using the battery is unable to boot due to abnormal component matching. In addition, long-term use may lead to a significant increase in a risk of piercing a separator by a Li dendrite. As a result, the battery is short-circuited inside and discharges electricity abnormally. Finally, it is easy to cause partial thermal runaway of the battery, resulting in a risk that a mobile phone or notebook computer using the battery catches fire.

### SUMMARY

In view of this, the present disclosure provides a positive electrode plate, a battery cell, and a battery. According to the present disclosure, a positive electrode plate and a negative electrode plate are designed to have a same width, to resolve a problem of poor coverage of a positive electrode and a negative electrode caused during preparation of a battery cell, thereby greatly improving safety of a battery.

To achieve the foregoing objective of the present disclosure, the present disclosure provides the following technical solutions.

The present disclosure provides a positive electrode plate. The positive electrode plate includes a current collector, an active material layer, a first insulation layer, and a second insulation layer.

The current collector has a first surface and a second surface that are disposed opposite each other; the first surface is sequentially provided with a first region, a second region, and a third region along a short side; and the second surface is sequentially provided with a fourth region, a fifth region, and a sixth region along a short side.

The active material layer is disposed in the second region and the fifth region.

The first insulation layer is disposed in the first region, the third region, the fourth region, and the sixth region.

The second insulation layer is disposed on the active material layer and the first insulation layer.

The present disclosure further provides a battery cell. The battery cell includes a negative electrode plate and the foregoing positive electrode plate, where the negative electrode plate has a same width as the positive electrode plate; and the battery cell does not include any separator.

The present disclosure further provides a battery. The battery includes the foregoing positive electrode plate or the foregoing battery cell.

In the present disclosure, electrode plates of a lithium-ion battery are produced as electrode plates that have a same width (as shown in FIG. 1), to resolve problems such as poor coverage of the electrode plates. When the positive electrode plate and a negative electrode plate are designed to have a same width, in a case that no separator is used for traction, edges of the positive electrode plate and the negative electrode plate are overlapped, and coverage of the positive electrode plate and the negative electrode plate is ensured. This facilitates winding or stacking of the positive electrode plate and the negative electrode plate. Conventionally, a width of a positive electrode plate is less than a width of a negative electrode plate. To achieve a technical effect that electrode plates have a same width, and to make up a width of a conventional positive electrode plate, in the present disclosure, a current collector is widened, and each of a long side and a surface of a positive electrode plate is provided with a first insulation layer and a second insulation layer (as shown in FIG. 2A, FIG. 2B, FIG. 3, and FIG. 4). The second insulation layer is disposed on an active material layer and the first insulation layer, which means that the second insulation layer is disposed on a side, away from the current collector, of each of the active material layer and the first insulation layer (as shown in FIG. 3). A probability that a positive electrode plate and a negative electrode plate are flush with each other or spiral can be greatly reduced by implementing the foregoing measures, which ensures that a yield of an entire winding step can be significantly increased, and ensures a capacity ratio between a positive electrode and a negative electrode. Safety performance of the battery in the present disclosure is far higher than that of all existing batteries that have separator components, so that all results of furnace temperature tests and nail penetration performance tests of the battery show that the performance of the battery is significantly improved.

### BRIEF DESCRIPTION OF THE DRAWINGS

FIG. 1 is a schematic diagram of a positive electrode plate and a negative electrode plate that have a same width according to the present disclosure.

FIG. 2A is a schematic top sectional view of some positive electrode plates according to the present disclosure.

FIG. 2B is a schematic top sectional view of some positive electrode plates according to the present disclosure.

FIG. 3 is a schematic side sectional view of a positive electrode plate according to the present disclosure.

FIG. 4 shows (a short-side view of) a setting of a region of a surface of a positive electrode current collector according to the present disclosure.

FIG. 5 is a schematic diagram of a length-to-diameter ratio of ceramics.

FIG. 6 is a schematic diagram of electrostatic spinning using a solution of hydroxyapatite and ceramics.

FIG. 7A is a front view of a normal jelly roll.

FIG. 7B is a front view of a jelly roll whose positive and negative electrode plates have poor coverage according to the prior art.

FIG. 8A is a sectional view of some jelly rolls according to the present disclosure.

FIG. 8B is a sectional view of a defective jelly roll in which a flush phenomenon occurs according to the prior art.

FIG. 8C is a sectional view of a defective jelly roll in which a spiral phenomenon occurs according to the prior art.

FIG. 9 is a brief schematic diagram of a winding structure.

### DETAILED DESCRIPTION OF THE EMBODIMENTS

The present disclosure provides a positive electrode plate, a battery cell, and a battery. Those skilled in the art may appropriately improve implementation of process parameters with reference to content herein. It should be particularly noted that all similar replacements and modifications are apparent to those skilled in the art and are deemed to be included in the present disclosure. Methods and applications of the present disclosure have been described by using preferred embodiments. It is apparent to relevant personnel that the methods and applications described herein can be modified or appropriately modified and combined without departing from the content, spirit, and scope of the present disclosure.

The present disclosure provides a positive electrode plate. The positive electrode plate includes a current collector, an active material layer, a first insulation layer, and a second insulation layer.

The current collector includes a first surface and a second surface that are disposed opposite each other; the first surface is sequentially provided with a first region, a second region, and a third region along a short side; and the second surface is sequentially provided with a fourth region, a fifth region, and a sixth region along a short side.

The active material layer is disposed in the second region and the fifth region.

The first insulation layer is disposed in the first region, the third region, the fourth region, and the sixth region.

The second insulation layer is disposed on the active material layer and the first insulation layer.

In some embodiments, a thickness of the first insulation layer is less than or equal to a thickness of the active material layer; and the first insulation layer has not only a capability of adjusting a capacity ratio between a positive electrode and a negative electrode, but also a function of adsorbing an electrolyte solution.

In some embodiments, a thickness of the first insulation layer ranges from 10 μm to 25 μm.

In some embodiments, a width of the first insulation layer ranges from 0.3 mm to 0.8 mm (for example, is 0.3 mm, 0.4 mm, 0.5 mm, 0.6 mm, 0.7 mm, or 0.8 mm). In the present disclosure, in consideration of a difference between electrode plates of a conventional positive electrode and a corresponding negative electrode ranging from 1.2 mm to 1.8 mm (the difference is used to ensure that a capacity of the negative electrode is greater than a capacity of the positive electrode, thereby ensuring that all Li ions from the positive electrode can be accommodated to avoid formation of a Li dendrite), the first insulation layer having a specific width (the width ranges from 0.3 mm to 0.8 mm) is disposed on a long side of the positive electrode. The first insulation layer has high infiltration, so that infiltration of the positive electrode plate can be improved to some extent.

In a specific embodiment provided in the present disclosure, a width of the first insulation layer is 0.5 mm.

In some embodiments, a thickness of the second insulation layer ranges from 3 μm to 20 μm (for example, is 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, or 20 μm); and functions of the second insulation layer include: isolating a positive electrode from a negative electrode, conducting Li ions, and adsorbing an electrolyte solution.

In some embodiments, a thickness of the second insulation layer ranges from 5 μm to 15 μm.

In some embodiments, a width of the second insulation layer is greater than a width of the active material layer.

The main function of the second insulation layer is to act as an insulating layer, and it only needs to completely cover the active material layer. In some embodiments, a difference between a width of the second insulation layer and a width of the active material layer is at least 0.1 mm.

In some embodiments, a width of the second insulation layer is less than or equal to a width of the current collector.

In some embodiments, a difference between a width of second insulation layer and a width of the current collector ranges from 0.7 mm to 1.6 mm.

In some embodiments, a width of the second insulation layer ranges from 5 mm to 200 mm.

In some embodiments, a width of the active material layer ranges from 5 mm to 200 mm.

In some embodiments, a width of the current collector ranges from 5 mm to 200 mm.

In some embodiments, “5 mm to 200 mm” may be, for example, 5 mm, 10 mm, 20 mm, 50 mm, 100 mm, 150 mm, or 200 mm.

In a specific embodiment provided in the present disclosure, a width of the second insulation layer is equal to a width of the current collector.

In some embodiments, a thickness of the active material layer ranges from 10 μm to 100 μm (for example, 10 μm, 20 μm, 30 μm, 40 μm, 50 μm, 60 μm, 70 μm, 80 μm, 90 μm, or 100 μm).

In an embodiment provided in the present disclosure, a thickness of the active material layer ranges from 30 μm to 50 μm.

In some embodiments, the first insulation layer is an electrospun layer or a noctilucent material layer.

In the present disclosure, the second insulation layer only needs to be a material having an insulating function. In some embodiments, the second insulation layer is an insulation film or an electrospun layer. In a specific embodiment provided in the present disclosure, the second insulation layer is an electrospun layer.

In some embodiments, the insulation film includes an organic matter and/or an inorganic matter.

In some embodiments, the inorganic matter includes at least one of aluminum oxide, silicon oxide, oxide ceramics, or barium sulfate.

In some embodiments, the organic matter includes polyvinylidene difluoride (PVDF) and/or polytetrafluoroethylene (PTFE).

In some embodiments, a mass ratio of the organic matter to the inorganic matter is (0 to 10):(10 to 0), the values are not 0 at the same time. “0 to 10” may be, for example, 0, 2, 4, 6, 8, or 10; “10 to 0” may be, for example, 0, 2, 4, 6, 8, or 10.

In some embodiments, the electrospun layer includes a skeleton-type material and an adhesive polymer.

In some embodiments, a mass ratio of the skeleton-type material to the adhesive polymer is (1 to 10):(0.1 to 1).

In some embodiments, a mass ratio of the skeleton-type material to the adhesive polymer is (1 to 10): 1, for example, is 1:1, 2:1, 3:1, 4:1, 5:1, 6:1, 7:1, 8:1, 9:1, or 10:1.

In a specific embodiment provided in the present disclosure, a mass ratio of the skeleton-type material to the adhesive polymer is 6:1.

In some embodiments, the noctilucent material layer includes a noctilucent material; and the noctilucent material includes at least one of rear earth aluminate or rear earth silicate.

In some embodiments, a porosity of the electrospun layer ranges from 25% to 90%, for example, is 25%, 30%, 40%, 50%, 60%, 70%, 80%, or 90%. In some embodiments, a porosity of the electrospun layer ranges from 30% to 90%. A spun layer obtained via spinning has a relatively high porosity, so that such a spun layer has a good electrolyte solution adsorption capacity. This structure is beneficial for not only Li transmission, but also structural stabilization and heat dissipation. Therefore, lithium-ion batteries of this series have excellent performance in furnace temperature and nail penetration.

In some embodiments, the skeleton-type material includes hydroxyapatite (Ca₁₀(PO₄)₆(OH)₂), or includes hydroxyapatite and ceramics.

In some embodiments, a particle size distribution of hydroxyapatite particles is as follows: D₁₀ ranges from 0.02 μm to 0.06 μm; D₅₀ ranges from 0.8 μm to 1.2 μm; and D₉₉ ranges from 2.0 μm to 3.3 μm.

In some embodiments, the ceramics include but are not limited to at least one of TiO₂, Al₂O₃, MgO, Mg(OH)₂, Al(OH)₃, boehmite, or SiO₂.

In some embodiments, a length-to-diameter ratio of particles of the ceramics ranges from 0.5 to 5, for example, may be 0.5, 1, 1.5, 2, 2.5, 3, 3.5, 4, 4.5, or 5.

The length-to-diameter ratio of the ceramics used in the present disclosure has a specific specification, that is, ranges from 0.5 to 5. This type of ceramics have a good specific surface area, and can be structurally complementary to hydroxyapatite, so that the formed spun layer has an obvious pore structure. Ceramic powder having such a length-to-diameter ratio is beneficial for not only Li⁺ transmission, but also structural stabilization and heat dissipation.

In a specific embodiment provided in the present disclosure, a length-to-diameter ratio of particles of the ceramics is 3.

In the present disclosure, a very thin spun layer (the first insulation layer and the second insulation layer) is prepared on either surface of the positive electrode via electrostatic spinning using an adhesive polymer (an adhesive) and a skeleton-type material such as nano-scale hydroxyapatite and/or ceramics. A spinning wire has a diameter ranging from 200 nm to 300 nm (a nano-scale mesh structure), completely covers both surfaces of the positive electrode plate, and may replace a structure of a conventional separator layer, thereby effectively separating the positive electrode plate from the negative electrode plate.

A thermal abuse test is to test heat tolerance of a battery at a specific temperature. A structure of the spun layer (the first insulation layer and the second insulation layer) on the upper surface of the positive electrode plate can still remain complete at a temperature above 400° C. In addition, the skeleton-type material such as hydroxyapatite and ceramics has a specific flame retardance, so that a specific structure can be maintained at a high temperature, thereby avoiding internally short-circuiting of a battery cell that is caused by short-circuiting between the positive electrode plate and the negative electrode plate. In this way, safety performance of the battery can be improved to a new level while a winding or stacking coverage of the battery is improved, so that a furnace temperature pass rate and a nail penetration pass rate of the battery are improved continuously.

In some embodiments, the skeleton-type material includes hydroxyapatite and ceramics; and a mass ratio of hydroxyapatite to ceramics is (1 to 100):(1 to 100), where “1 to 100” for example, may be 1, 2, 3, 4, 5, 10, 20, 40, 60, 80, or 100.

In some embodiments, the skeleton-type material includes hydroxyapatite and ceramics; and a mass ratio of hydroxyapatite to ceramics is (1 to 10):(1 to 10).

In some other embodiments, the skeleton-type material includes hydroxyapatite and ceramics; and a mass ratio of hydroxyapatite to ceramics is (1 to 5):(1 to 5).

In a specific embodiment provided in the present disclosure, a mass ratio of hydroxyapatite to ceramics is 2:1.

In some embodiments, the adhesive polymer includes but is not limited to at least one of polyvinylidene difluoride (PVDF), polyvinylpyrrolidone, a copolymer of vinylidene fluoride-hexafluoropropylene, polyacrylonitrile, sodium carboxymethyl cellulose, sodium polyacrylate, polyacrylic acid, polyacrylic acid ester, a copolymer of styrene-butadiene, a copolymer of butadiene-acrylonitrile, polyvinyl alcohol, poly(methyl acrylate), polymethyl methacrylate, poly(ethyl acrylate), or a copolymer of polyacrylic acid-styrene.

In a specific embodiment provided in the present disclosure, each of the first insulation layer and the second insulation layer is an electrospun layer including hydroxyapatite, ceramics, and PVDF. The electrospun layer is easy to infiltrate with an electrolyte solution, so that the electrolyte solution outside a jelly roll body can be transported to an interior of the electrode plate. Therefore, infiltration of the electrode plate is improved to some extent.

In some embodiments, the first insulation layer is a noctilucent material layer; and a noctilucent material in the noctilucent material layer includes at least one of rear earth aluminate or rear earth silicate. The rear earth aluminate may include at least one of 4 SrO 0.7Al₂O₃: Eu²⁺, SrAl₂O₄: Eu²⁺, SrAl₂O₄: Eu²⁺,Dy³⁺, SrAl₂O₄: Eu²⁺, Nd³⁺, SrAl₂O₄: Eu²⁺,Dy³⁺, Nd³⁺, Sr₄Al₁₄O₂: Eu²⁺, Sr₄Al₁₄O₂: Eu²⁺,Dy³⁺, or Ca₂Al₂O₄: Eu²⁺,Dy³⁺. The rear earth silicate may include at least one of Sr₂MgSi₂O₇: Eu²⁺,Dy³⁺, Sr₂MgSi₂O₇: Eu²⁺,Dy³⁺,Nd³⁺, or Sr₂ZnSi₂O₇: Eu²⁺,Dy³⁺.

In some embodiments, the noctilucent material layer further includes PVDF

In some embodiments, a mass ratio of the noctilucent material to PVDF is (9 to 19): (1 to 10), where “9 to 19” may be, for example, 9, 11, 13, 15, 17, or 19; and “1 to 10” may be, for example, 1, 2, 4, 6, 8, or 10.

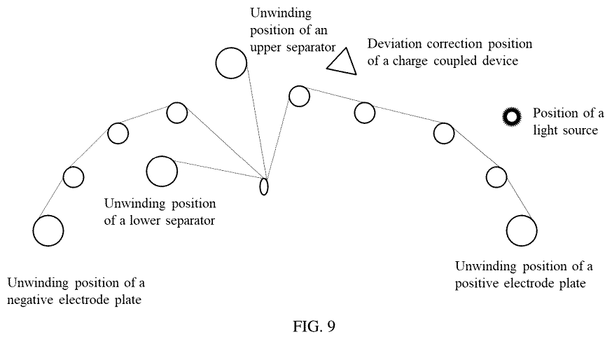

Being irradiated with a specific light source (ultraviolet light, sunlight, day lamp light, indoor ambient stray light, or the like), the noctilucent material in the present disclosure can emit light. Then, a target charge coupled device (charge coupled device, CCD) can recognize an edge of the positive electrode plate (as shown in FIG. 9) based on the light source, so that a traveling position of the positive electrode plate can be adjusted in real time. In addition, the positive electrode plate and the negative electrode plate themselves have a same width. A probability that a positive electrode plate and a negative electrode plate are flush with each other or spiral can be greatly reduced by implementing the foregoing measures, which ensures that a yield of an entire winding step can be significantly increased.

The present disclosure further provides a preparation method of the foregoing positive electrode plate, including the following steps:

First, a positive electrode active material layer is disposed in a second region and a fifth region of a current collector.

Then, a first insulation layer is disposed in a first region, a third region, a fourth region, and a sixth region of the current collector.

Finally, second insulation layers are disposed on two side surfaces of the current collector.

In an embodiment provided in the present disclosure, the preparation method of the foregoing positive electrode plate includes:
applying a positive electrode active material layer slurry on two side surfaces of the current collector (in two regions: the second region and the fifth region), to obtain a current collector coated with active material layers;
mixing a skeleton-type material, an adhesive polymer, and an appropriate amount of a highly polar organic solvent to obtain a spinning solution;
performing electrostatic spinning using the spinning solution on long sides (in four regions: the first region, the third region, the fourth region, and the sixth region) of the current collector coated with the active material layers, to prepare first insulation layers; and then, performing electrostatic spinning on two side surfaces of the current collector coated with the active material layers, to prepare second insulation layers.

In another embodiment provided in the present disclosure, the preparation method of the foregoing positive electrode plate includes:
applying a positive electrode active material layer slurry on two side surfaces of the current collector (in two regions: the second region and the fifth region), to obtain a current collector coated with active material layers;
mixing a noctilucent material with PVDF and an appropriate amount of a highly polar organic solvent to obtain a noctilucent solution;
applying the noctilucent solution on long sides (in four regions: the first region, the third region, the fourth region, and the sixth region) of the current collector coated with the active material layers, to prepare first insulation layers; and then, performing electrostatic spinning on two side surfaces of the current collector coated with the active material layers, to prepare second insulation layers.

In some embodiments, the highly polar organic solvent includes at least one of N-methylpyrrolidone (NMP), dimethylacetamide (DMA), N,N-dimethylformamide (DMF), dioxane, m-cresol, or chloroform.

In some embodiments, a voltage of a high-voltage power supply of electrostatic spinning ranges from 0 KV to 50 KV; a double-injection pump setting is used; a minimum liquid supply amount is 10 μL/h; an environment was at room temperature of 25±3° C.; and a humidity is less than or equal to 10% RH.

The present disclosure further provides a battery cell. The battery cell includes a negative electrode plate and the foregoing positive electrode plate, where the negative electrode plate has a same width as the positive electrode plate; and the battery cell does not include any separator.

In a specific embodiment provided in the present disclosure, the battery cell is a jelly roll or a stacked cell.

In some embodiments, the negative electrode plate includes a negative electrode current collector and negative electrode active material layers. The negative electrode active material layers are disposed on two side surfaces of the negative electrode current collector.

In a specific embodiment provided in the present disclosure, the negative electrode current collector is copper foil.

The present disclosure further provides a battery. The battery includes the foregoing positive electrode plate or the foregoing battery cell.

Compared with the prior art, the present disclosure has the following beneficial effects.

Firstly, for poor coverage of an existing battery cell structure (separator/positive electrode/separator/negative electrode), a current collector is widened in the present disclosure, and skeleton-type materials such as hydroxyapatite and ceramics are spun on an edge of the positive electrode plate via electrostatic spinning. Then, double-sided spinning is performed on the positive electrode plate. Widths of the positive electrode plate and a negative electrode plate are kept the same to ensure coverage of the positive electrode plate and the negative electrode plate. Then, the positive electrode plate and the negative electrode plate are directly attached for use. Therefore, the electrode plates of the battery are directly machinable, to reduce poor coverage of the battery from about 1.5% to about 0.02%, and reduce a spiral proportion from about 0.5% to 0.

Secondly, in the present disclosure, furnace temperature safety of an original lithium-ion battery having a PE or PP type separator can be raised from 130° C. to a level above 200° C. In addition, a nail penetration pass rate of the battery reaches 100%.

Thirdly, in the present disclosure, nano-scale skeleton-type materials such as hydroxyapatite and ceramics are spun on edges and surfaces of the positive electrode plate according to an electrostatic spinning technology, to play a direct contact role of isolating the negative electrode plate. Then, the positive electrode plate, the negative electrode plate, and an electrolyte solution are assembled into a lithium-ion battery. Subsequently, safety performance of the battery is tested, and the following results are obtained: furnace temperature tests for safety performance of the battery show that the battery can safely pass the tests at temperatures ranging from 200° C. to 250° C.; and the battery subjected to nail penetration tests can achieve a pass rate of 100%.

Lastly, in the present disclosure, long-acting noctilucent powder is applied to an edge position of the positive electrode plate by using an oily slurry, to play not only a direct contact role of isolating the negative electrode plate, but also a role of positioning the positive electrode plate. The obtained coating is irradiated with UV or another light source for more than 60 seconds in advance. After being left standing for about 60 seconds, the position with the coating glows spontaneously. Then, the edge of the positive electrode plate is obtained via CCD reception and processing. Subsequently, edge overlapped attaching and winding are performed on the positive electrode plate and the negative electrode plate. This design scheme can greatly reduce Li ion deposition caused by an uneven current density at a portion of the battery, avoid deposition and growth of a Li dendrite, and avoid a risk of internal self-discharge caused by puncture of a separator, so that a yield of jelly rolls can be increased stably, and the jelly rolls can be output stably. This design scheme can reduce original poor coverage to 0.005%, and reduce a spiral proportion from about 0.5% to 0.

Areagent, instrument, material, or the like used in the present disclosure are commercially available.

In this embodiment, hydroxyapatite may be a commercially available product.

Alternatively, hydroxyapatite may be prepared according to the following preparation method (hydrothermal method):

S1: 22 g of a CaCl₂) aqueous solution is dropwise added into a mixed solution of 600 g of ethanol and 600 g of oleic acid; stirring is performed for 100 minutes continuously (at a stirring frequency of 10 Hz); and then, 70 g of a NaOH aqueous solution is dropwise added to obtain a calcium oleate precursor.

S2: the precursor is stirred continuously for 100 minutes (at the stirring frequency of 10 Hz); then, 28.8 g of a NaH₂PO₄ aqueous solution is dropwise added to the precursor; the mixture is transferred into a 3 L reactor; and a reaction is carried out in an oil bath at 180° C. for 36 hours; and an obtained reaction product is centrifuged and washed with deionized water and ethanol respectively for at least three times, followed by drying to obtain hydroxyapatite for standby use.

In this embodiment, a main component of a material product of long-acting noctilucent powder is a mixture: 4 SrO 0.7Al₂O₃: Eu²⁺, namely, noctilucent powder from Longbo Landscape with a CAS No. of 12004347, where its density is 3.6 g/cm³; and a good stability can be maintained at a temperature ranging from −60° C. to 600° C.

Terms are explained as follows.

Hydrothermal method: a method of producing a material in a sealed pressure vessel by using water as a solvent and dissolving and recrystallizing powder sequentially. Compared with another powder preparation method, powder prepared according to the hydrothermal method has advantages of complete crystal particle development, small particle size, even distribution, relatively light particle aggregation, relatively cheap raw materials, high possibility of obtaining a suitable stoichiometric matter and crystal shape, and the like.

Full charging system for batteries: constant-current and constant-voltage charging is performed at a specific rate (0.7 C) in a 25° C. constant-temperature room; when a cut-off voltage is reached, charging is jumped to a constant-voltage mode; charging is cut off when a cut-off current (generally, 0.02 C) is reached, which is considered as charging being stopped; and then, a furnace temperature test is carried out.

Nail penetration test: five 0.7 C/0.7 C charge-discharge cycles are performed on a battery cell; and a nail penetration test is completed within two days after the cycles, where nail penetration is performed after the battery is fully charged. An iron nail with a diameter of 4 mm passed through one of a left position, a central position, or a right position of the battery cell, where a nail speed is 30 mm/s; the nail is left in the battery; the distance between a left nail penetration position or a right nail penetration position and an edge is 7.5+2.5 mm; nail penetration is required to be performed from a deep pit surface. Observing is performed for 1 hour or till a highest temperature on a surface of the battery cell drops to a peak value of 10° C. or below; and then the test is stopped. Determining criteria are: no fire and no explosion.

Furnace temperature test: a temperature is raised from a room temperature of 25° C. by 5° C./min to a specified temperature (generally, 130° C./135° C./140° C./145° C./150° C./155° C./160° C./165° C./170° C./175° C./180° C./185° C./190° C./195° C./200° C./205° C./210° C./215° C./220° C./225° C./230° C./235° C./240° C./245° C./250° C.), to enter a constant-temperature phase; the temperature is kept for a specific time (generally, 10 minutes/30 minutes/60 minutes); and then, a thermostat is opened to confirm whether the battery catches fire, is exploded, or fumes, where if the battery does not catch fire, is not exploded, and does not fume, it is determined that the battery can pass the furnace temperature test.

Energy density of a battery refers to the amount of energy that a battery can store within a given mass or volume. It is typically expressed as volumetric energy density (Wh/L), calculated by the formula: Volumetric energy density=Battery capacity×Discharge voltage/Battery volume, unit: Wh/L.

Method for characterizing self-discharge: the battery voltage U1 is tested at time t1, and after a period of time, the battery voltage U2 is tested at time t2. The calculation formula is: K (self-discharge)=(U1-U2)/(t2-t1), unit: mV/h.

Light-emitting principle of fluorescence: When ultraviolet light is irradiated on some atoms, energy of the light causes some electrons around a nucleus to transit from an original orbit to an orbit with higher energy, that is, transit from a ground state to a first excited singlet state, a second excited singlet state, or the like. The first excited singlet state, the second excited singlet state, or the like are unstable, so that the ground state may be restored. When the electrons restore from the first excited singlet state to the ground state, energy is released in a form of light, and therefore fluorescence is generated. Fluorescence is light emitted after a substance absorbs light or other electromagnetic radiation. In most cases, a light-emitting wavelength is longer than an absorption wavelength, and energy is lower.

Poor coverage-flush: a positive electrode plate and a negative electrode plate are wound according to specific widths. Because the electrode plates are objects having flat structures and obtained by performing circumferential movement around a winding needle under the traction of separators, and the positive electrode plate is generally narrower than the negative electrode plate, on one side of a jelly roll, the positive electrode plate and the negative electrode plate are at a same height or partially exposed due to a limited deviation correction capability or a wavy edge of an incoming material. When it is seen from the top that the positive electrode and the negative electrode are on a same horizontal plane, the jelly roll in this case is called poor flush.

Poor coverage-spiral: a positive electrode plate and a negative electrode plate are wound according to specific widths. Because the electrode plates are objects having flat structures and obtained by performing circumferential movement around a winding needle under the traction of separators, and the positive electrode plate is generally narrower than the negative electrode plate, the following defect occurs: the positive electrode plate and the negative electrode plate that are under traction rise or fall spirally to some extent with a winding needle due to a limited deviation correction capability or a wavy edge of an incoming separator material. The defect is similar to a helix structure of DNA. Emergence of this structure causes the jelly roll to be extremely high. The excessive height leads to a design of a cavity exceeding an aluminum-plastic film. As a result, a self-discharge risk increases due to failure in completing encapsulation, Li ion deposition, or Li crystal formation.

The present disclosure is further described below with reference to examples.

### EXAMPLE 1 to EXAMPLE 5

### 1. Structure and Preparation Method of a Positive Electrode Plate

### (1) Structure of the Positive Electrode Plate

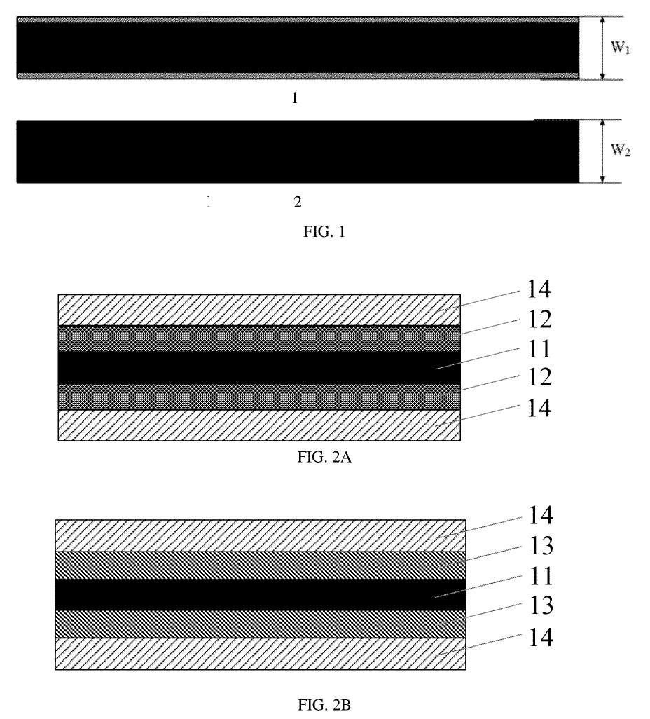

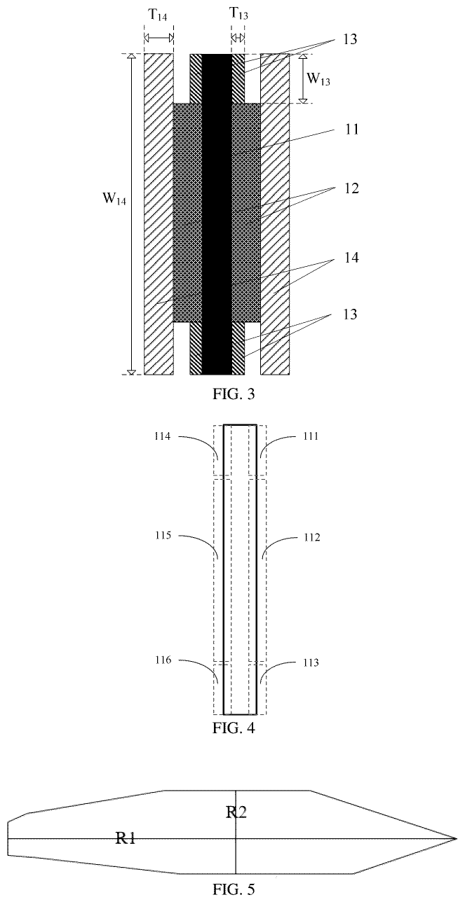

As shown in FIG. 1, FIG. 2A, FIG. 2B, FIG. 3, and FIG. 4, the positive electrode plate 1 provided in this example included a current collector 11, an active material layer 12, a first insulation layer 13, and a second insulation layer 14; and a width of the positive electrode plate was W₁. Where W₁=W₂; W₁₃ denotes a width of a first insulation layer 13; T₁₃ denotes a thickness of the first insulation layer 13; W₁₄ denotes a width of a second insulation layer 14; and T₁₄ denotes a thickness of the second insulation layer 14.

The current collector included a first surface and a second surface that were disposed opposite each other. The first surface was sequentially provided with a first region 111, a second region 112, and a third region 113 along a short side. The second surface was sequentially provided with a fourth region 114, a fifth region 115, and a sixth region 116 along a short side.

The active material layer 12 was disposed in the second region 112 and the fifth region 115.

The first insulation layer 13 was disposed in the first region 111, the third region 113, the fourth region 114, and the sixth region 116.

The second insulation layer 14 was disposed on the active material layer 12 and the first insulation layer 13.

A thickness T₁₃ of the first insulation layer 13 was 10 μm; and a width W₁₃ thereof was 0.5 mm. A thickness of the active material layer 12 was 30 μm; a width thereof was 0.5 mm; and a length thereof was equal to a length of the current collector.

A width W₁₄ of the second insulation layer 14 was equal to a width of the current collector 11. A thickness T₁₄ of the second insulation layer 14 ranged from 3 μm to 20 μm (for details, refer to Table 1). A length of the second insulation layer 14 was equal to a length of the current collector 11.

The current collector 11 was aluminum foil; and a thickness thereof was 9 μm.

The first insulation layer 13 or the second insulation layer 14 was an electrospun layer. Porosities of both the first insulation layer 13 and the second insulation layer 14 were 80%.

### (2) Preparation Method of the Positive Electrode Plate

a. A positive electrode active material slurry was applied on two side surfaces of a current collector, to obtain a current collector coated with the active material. The positive electrode active material layer included the following components: 98.0 wt % of a positive electrode active material that was LiCoO₂; 1.0 wt % of a conductive agent that was conductive carbon black; and 1.0 wt % of a binder that was polyvinylidene difluoride.

b. Hydroxyapatite, ceramic powder (Al₂O₃ whose particle length-to-diameter ratio was 3, where a schematic diagram thereof is as shown in FIG. 5; R₁ denotes a length of a ceramic particle; and R₂ denotes a diameter of the ceramic particle), and PVDF (hydroxyapatite: ceramics: PVDF=4:2:1) were mixed in NMP, followed by stirring (at a stirring frequency of 10 Hz) for 100 minutes, to finally obtain a spinning solution.

c. Electrostatic spinning was performed, by using the spinning solution, on a long side of the current collector coated with the active material, to obtain a first spun layer (namely, a first insulation layer).

Then, electrostatic spinning was performed on two side surfaces of the current collector coated with the active material, to obtain a second spun layer (namely, a second insulation layer).

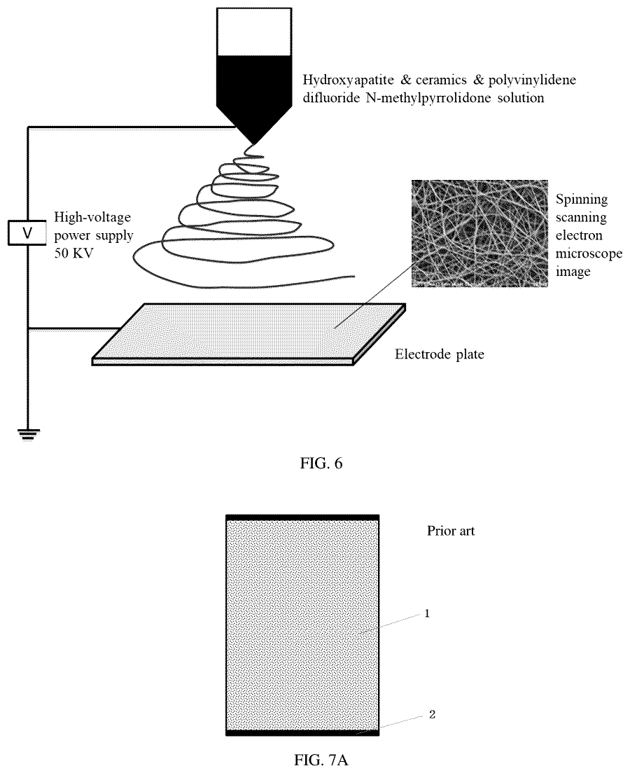

Parameter specifications of electrostatic spinning were as follows: a 40 KV high-voltage power supply was used; a double-injection pump setting was used; a liquid supply amount was 30000 μL/h; an environment was at room temperature of 25+3° C.; and a humidity was less than or equal to 10% RH. FIG. 6 shows a schematic diagram of electrostatic spinning.

2. Structure and preparation method of a negative electrode plate

### (1) Structure of the Negative Electrode Plate

The negative electrode plate 2 provided in this example included a negative electrode current collector and negative electrode active material layers. The negative electrode current collector was copper foil and had a thickness of 5 μm; and a width W₂ thereof was the same as the width of the foregoing positive electrode plate. The negative electrode active material layers were disposed on two side surfaces of the negative electrode current collector.

### (2) Preparation Method of the Negative Electrode Plate

A negative electrode active material slurry was applied on the two side surfaces of the negative electrode current collector, to obtain a negative electrode plate. The negative electrode active material layer included the following components: 96.5% of a negative electrode active material that was mesocarbon microbeads; 0.9% of a conductive agent that was carbon nanotubes; 1.3% of an adhesive that was SBR; and 1.3% of a dispersing agent that was sodium carboxymethyl cellulose/CMC.

### 3. Assembly of a Battery

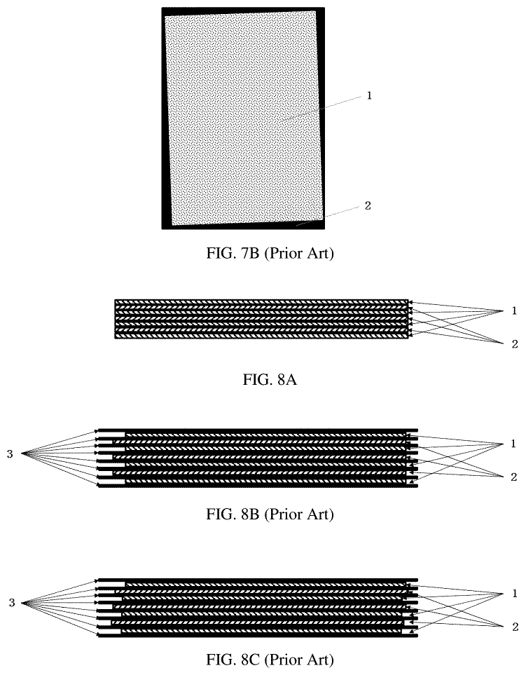

The foregoing obtained positive electrode plate 1 and negative electrode plate 2 were overlapped and wound to obtain a jelly roll, or stacked to obtain a stacked cell. A poor coverage item corresponding to the jelly roll or the stacked cell was recorded. Encapsulation, electrolyte injection, formation, secondary encapsulation, sorting, and OCV were performed to obtain a battery. FIG. 7A is a front view of a normal jelly roll. FIG. 7B is a front view of a jelly roll whose positive and negative electrode plates have poor coverage. FIG. 8A is a sectional view of some jelly rolls according to the present disclosure, where the jelly rolls are normal jelly rolls. FIG. 8B is a sectional view of a defective jelly roll in which a flush phenomenon occurs. FIG. 8C is a sectional view of a defective jelly roll in which a spiral phenomenon occurs. The positive electrode plate is denoted by 1; the negative electrode plate is denoted by 2; and the separator is denoted by 3.

A formula of an electrolyte solution in the battery is: EC: EMC: DEC=3:5:2. A molar proportion of LiPF₆ was 1.2 mol/L.

### EXAMPLE 6

Example 6 was operated according to the method in Example 2, and differed from Example 2 as follows: The first insulation layer and the second insulation layer did not include ceramic powder. Hydroxyapatite: PVDF=6:1.

### Group of EXAMPLES 7

Example 7a was operated according to the method in Example 2, and differed from Example 2 as follows: the ceramic powder in the first insulation layer and the second insulation layer was boehmite.

Example 7b was operated according to the method in Example 2, and differed from Example 2 as follows: the ceramic powder in the first insulation layer and the second insulation layer was Al₂O₃.

Example 7c was operated according to the method in Example 2, and differed from Example 2 as follows: the ceramic powder in the first insulation layer and the second insulation layer was SiO₂.

Example 7d was operated according to the method in Example 2, and differed from Example 2 as follows: the ceramic powder in the first insulation layer and the second insulation layer was MgO.

### EXAMPLE 8

Example 8 was operated according to the method in Example 2, and differed from Example 2 as follows: the first insulation layer was a noctilucent material layer; and the noctilucent material layer included 4 SrO 0.7Al₂O₃: Eu²⁺ and PVDF.

A preparation method of the positive electrode plate was as follows:
a. A positive electrode active material slurry was applied on two side surfaces of a current collector, to obtain a current collector coated with the active material. Components of the positive electrode active material layer and proportions thereof were similar to those in Example 2.
b. The noctilucent material, PVDF, and NMP were mixed to obtain an oily slurry (a noctilucent solution). Mass proportions of materials were as follows:
Noctilucent material 35%
PVDF 10%
NMP 55%
Hydroxyapatite, ceramic powder (Al₂O₃ whose particle length-to-diameter ratio was 3, where a schematic diagram thereof is as shown in FIG. 5), and PVDF (hydroxyapatite: ceramics: PVDF=4:2:1) were mixed in NMP, followed by stirring (at a stirring frequency of 10 Hz) for 100 minutes to finally obtain a spinning solution.
c. In a manner of extrusion transfer coating, a noctilucent solution was applied on long sides of the current collector coated with the active material, to prepare first insulation layers; and
then, electrostatic spinning using the spinning solution was performed on two side surfaces of the current collector coated with the active material, to obtain a second insulation layer.

### EXAMPLE 9

Example 9 was operated according to the method in Example 2, and differed from Example 2 as follows: a width W₁₄ of the second insulation layer 14 was less than to a width of the current collector 11; a thickness T₁₄ of the second insulation layer 14 was 5 μm (for details, refer to Table 1); a length of the second insulation layer 14 was equal to a length of the current collector 11; and a width of the second insulation layer was 0.5 mm less than a width of the current collector 11.

### COMPARATIVE EXAMPLE 1

In this Comparative Example, a conventional battery cell structure with a separator was used:

The positive electrode plate included a positive electrode current collector and a positive electrode active material layer; the positive electrode current collector was aluminum foil; and a thickness thereof was 9 μm. The positive electrode active material layers were disposed on two side surfaces of the positive electrode current collector.

The negative electrode plate included a negative electrode current collector and negative electrode active material layers. The negative electrode current collector was copper foil and had a thickness of 5 μm; and a width thereof was greater than the width of the foregoing positive electrode plate. The negative electrode active material layers were disposed on two side surfaces of the negative electrode current collector.

The separator used a normal PE base film. A coating structure was 1+7+2+1, where 1 indicates that there was a 1 μm thick adhesive layer (the adhesive was a PVDF adhesive) on either surface; 2 denotes a 2 μm ceramic coating on a single surface; the ceramic coating used normal Al₂O₃ coating; and 7 indicates that the base film was a 7 μm PE base film.

The separator, the positive electrode plate, and the negative electrode plate were assembled to obtain a jelly roll. A corresponding poor coverage item was recorded. Then, encapsulation was performed; an electrolyte solution was injected to assemble a battery; and subsequently, formation, secondary encapsulation, sorting, and OCV were performed to obtain the battery.

### Battery Performance Test:

For data of poor coverage items of the batteries prepared in the foregoing Examples and Comparative Examples, refer to Table 1. Electric performance tests were carried out for the batteries prepared in the foregoing Examples and Comparative Examples. Test results are shown in Table 2.

TABLE 1

| | | Poor | Spiral |
|---|---|---|---|
| | Thickness (μm) of a second | flush | proportion |
| Group | insulation layer | (%) | (%) |
| Example 1 | 3 | 0.03 | 0 |
| Example 2 | 5 | 0.02 | 0 |
| Example 3 | 10 | 0.015 | 0 |
| Example 4 | 15 | 0.01 | 0 |
| Example 5 | 20 | 0.01 | 0 |
| Example 6 | 5 | 0.021 | 0 |
| Example 7a | 5 | 0.019 | 0 |
| Example 7b | 5 | 0.019 | 0 |
| Example 7c | 5 | 0.018 | 0 |
| Example 7d | 5 | 0.018 | 0 |
| Example 8 | 5 | 0.005 | 0 |
| Example 9 | 5 | 0.021 | 0.05 |
| Comparative | / | 1.2 | 0.3 |
| Example 1 | | | |

TABLE 2

| | Thickness | | | | | | | | |
|---|---|---|---|---|---|---|---|---|---|
| | (μm) of a | Stacked | Stacked | Stacked | Stacked | Stacked | Pass rate | | |
| | second | cell | cell | cell | cell | cell | of nail | Energy | Self- |
| | insulation | 130° C. | 135° C. | 200° C. | 225° C. | 240° C. | penetration | density | discharge |
| Group | layer | 60 minutes | 60 minutes | 60 minutes | 60 minutes | 60 minutes | tests | (Wh/L) | (mV/h) |
| Example 1 | 3 | 10/10 | 10/10 | 10/10 | 10/10 | 10/10 | 10/10 | 753 | 0.062 |
| | | PASS | PASS | PASS | PASS | PASS | PASS | | |
| Example 2 | 5 | 10/10 | 10/10 | 10/10 | 10/10 | 10/10 | 10/10 | 742 | 0.053 |
| | | PASS | PASS | PASS | PASS | PASS | PASS | | |
| Example 3 | 10 | 10/10 | 10/10 | 10/10 | 10/10 | 10/10 | 10/10 | 733 | 0.046 |
| | | PASS | PASS | PASS | PASS | PASS | PASS | | |
| Example 4 | 15 | 10/10 | 10/10 | 10/10 | 10/10 | 10/10 | 10/10 | 725 | 0.036 |
| | | PASS | PASS | PASS | PASS | PASS | PASS | | |
| Example 5 | 20 | 10/10 | 10/10 | 10/10 | 10/10 | 10/10 | 10/10 | 716 | 0.028 |
| | | PASS | PASS | PASS | PASS | PASS | PASS | | |
| Example 6 | 5 | 10/10 | 10/10 | 10/10 | 10/10 | 10/10 | 10/10 | 741 | 0.054 |
| | | PASS | PASS | PASS | PASS | PASS | PASS | | |
| Example 7a | 5 | 10/10 | 10/10 | 10/10 | 10/10 | 10/10 | 10/10 | 742 | 0.052 |
| | | PASS | PASS | PASS | PASS | PASS | PASS | | |
| Example 7b | 5 | 10/10 | 10/10 | 10/10 | 10/10 | 10/10 | 10/10 | 742 | 0.051 |
| | | PASS | PASS | PASS | PASS | PASS | PASS | | |
| Example 7c | 5 | 10/10 | 10/10 | 10/10 | 10/10 | 10/10 | 10/10 | 741 | 0.051 |
| | | PASS | PASS | PASS | PASS | PASS | PASS | | |
| Example 7d | 5 | 10/10 | 10/10 | 10/10 | 10/10 | 10/10 | 10/10 | 742 | 0.050 |
| | | PASS | PASS | PASS | PASS | PASS | PASS | | |
| Example 8 | 5 | 10/10 | 10/10 | 10/10 | 10/10 | 10/10 | 10/10 | 742 | 0.053 |
| | | PASS | PASS | PASS | PASS | PASS | PASS | | |
| Example 9 | 5 | 10/10 | 10/10 | 10/10 | 10/10 | 10/10 | 10/10 | 735 | 0.048 |
| | | PASS | PASS | PASS | PASS | PASS | PASS | | |
| Comparative | / | 10/10 | 2/10 | 0/10 | 0/10 | 0/10 | 0/10 | 730 | 0.042 |
| Example 1 | | PASS | PASS | PASS | PASS | PASS | PASS | | |

It may be learned from the foregoing test results that in the present disclosure, a conventional separator is omitted, and widths of a positive electrode plate and a negative electrode plate are set to be the same. This facilitates winding or stacking of the positive electrode plate and the negative electrode plate. It is found via tests that designing the widths of the positive electrode plate and the negative electrode plate to be the same may reduce poor coverage to below 0.03%. Assuming that poor coverage is 0.02% and 200 W jelly rolls are used per day, more than 2000 battery cells can be saved, and nearly 73 W jelly rolls may be saved per year.

As a thickness of a second insulation layer increases, a pass rate of furnace temperature tests for a battery cell is significantly improved. Heat resistance of the battery is raised from 130° C. to 240° C. A nail penetration pass rate of the battery directly reaches 100%.

However, when the thickness of the second insulation layer of the electrode plate decreases to less than 5 μm, a self-discharge capability of the battery is enlarged, which goes against long-term storage and use of the battery. When the thickness of the second insulation layer reaches 20 μm, compared with a normal separator whose entire thickness is occupied by the second insulation layer, an energy density per unit volume of the battery cell decreases significantly. When self-discharge and energy density are considered comprehensively, the second insulation layer can fully play its role when its thickness ranges from 5 m to 15 m, so that a furnace temperature pass rate of the battery can be improved without significantly reducing the energy density per unit volume of the battery.

The first insulation layer may play a direct contact role of isolating the negative electrode plate when being designed to be an electrospun layer or a noctilucent material layer. In the design of the noctilucent material layer in Example 8, the electrode plate may alternatively be positioned to cause an edge of the electrode plate to glow, so that a CCD can completely capture the edge of the electrode plate, and then overlap and wind the edges of the positive electrode plate and the negative electrode plate. This greatly reduces a coverage problem and a spiral problem of the positive electrode plate and the negative electrode plate, can greatly reduce Li ion deposition caused by an uneven current density at a portion of the battery, avoids deposition and growth of a Li dendrite, and avoids a risk of internal self-discharge caused by puncture of a separator, so that a yield of jelly rolls can be increased stably, and the jelly rolls can be output stably. In terms of energy density and self-discharge, the noctilucent material in Example 8 can be at a same level as the electrostatic spinning material in Example 1 to Example 7.

The foregoing descriptions are merely preferred implementations of the present disclosure. It should be noted that those of ordinary skill in the art may further make several improvements and refinements without departing from the principle of the present disclosure, and these improvements and refinements shall fall within the protection scope of the present disclosure.

What is claimed is:

1. A positive electrode plate, comprising a current collector, an active material layer, a first insulation layer, and a second insulation layer, wherein
the current collector comprises a first surface and a second surface that are disposed opposite each other; the first surface is sequentially provided with a first region, a second region, and a third region along a short side; and the second surface is sequentially provided with a fourth region, a fifth region, and a sixth region along a short side;
the active material layer is disposed in the second region and the fifth region;
the first insulation layer is disposed in the first region, the third region, the fourth region, and the sixth region; and
the second insulation layer is disposed on the active material layer and the first insulation layer.

2. The positive electrode plate according to claim 1, wherein a thickness of the first insulation layer is less than or equal to a thickness of the active material layer; and/or
a width of the second insulation layer is greater than a width of the active material layer; and/or
a width of the second insulation layer is less than or equal to a width of the current collector.

3. The positive electrode plate according to claim 1, wherein a width of the first insulation layer ranges from 0.3 mm to 0.8 mm; and/or
a thickness of the first insulation layer ranges from 10 μm to 25 μm; and/or
a width of the second insulation layer ranges from 5 mm to 200 mm; and/or
a thickness of the second insulation layer ranges from 3 μm to 20 μm; and/or
a width of the active material layer ranges from 5 mm to 200 mm; and/or
a thickness of the active material layer ranges from 10 μm to 100 μm; and/or
a width of the current collector ranges from 5 mm to 200 mm.

4. The positive electrode plate according to claim 1, wherein a thickness of the second insulation layer ranges from 5 μm to 15 μm; and/or
a thickness of the active material layer ranges from 30 μm to 50 μm.

5. The positive electrode plate according to claim 1, wherein a difference between a width of the second insulation layer and a width of the active material layer is at least 0.1 mm; and/or
a difference between a width of second insulation layer and a width of the current collector ranges from 0.7 mm to 1.6 mm.

6. The positive electrode plate according to claim 1, wherein the first insulation layer is an electrospun layer or a noctilucent material layer; and/or
the second insulation layer is an insulation film or an electrospun layer.

7. The positive electrode plate according to claim 6, wherein the electrospun layer comprises a skeleton-type material and an adhesive polymer.

8. The positive electrode plate according to claim 7, wherein a mass ratio of the skeleton-type material to the adhesive polymer is (1 to 10): (0.1 to 1); and/or
a porosity of the electrospun layer ranges from 25% to 90%.

9. The positive electrode plate according to claim 8, wherein a porosity of the electrospun layer ranges from 30% to 90%.

10. The positive electrode plate according to claim 7, wherein the skeleton-type material comprises hydroxyapatite, or comprises hydroxyapatite and ceramics; and/or
the adhesive polymer comprises at least one of polyvinylidene difluoride, polyvinylpyrrolidone, a copolymer of vinylidene fluoride-hexafluoropropylene, polyacrylonitrile, sodium carboxymethyl cellulose, sodium polyacrylate, polyacrylic acid, polyacrylic acid ester, a copolymer of styrene-butadiene, a copolymer of butadiene-acrylonitrile, polyvinyl alcohol, poly(methyl acrylate), polymethyl methacrylate, poly(ethyl acrylate), or a copolymer of polyacrylic acid-styrene.

11. The positive electrode plate according to claim 10, wherein the ceramics comprise at least one of TiO₂, Al₂O₃, MgO, AL(OH)₃, boehmite, or SiO₂.

12. The positive electrode plate according to claim 10, wherein a length-to-diameter ratio of particles of the ceramics ranges from 0.5 to 5.

13. The positive electrode plate according to claim 7, wherein the skeleton-type material comprises hydroxyapatite and ceramics; and a mass ratio of hydroxyapatite to ceramics is (1 to 100): (1 to 100).

14. The positive electrode plate according to claim 6, wherein the noctilucent material layer comprises a noctilucent material; and the noctilucent material comprises at least one of rear earth aluminate or rear earth silicate.

15. The positive electrode plate according to claim 14, wherein the rear earth aluminate comprises at least one of 4SrO 0.7Al₂O₃: Eu²⁺, SrAl₂O₄: Eu²⁺, SrAl₂O₄: Eu²⁺, Dy³⁺, SrAl₂O₄: Eu²⁺,Nd³⁺, SrAl₂O₄: Eu²⁺,Dy³⁺, Nd³⁺, Sr₄Al₁₄O₂: Eu²⁺, Sr₄Al₁₄O₂: Eu²⁺,Dy³⁺, or Ca₂Al₂O₄: Eu²⁺,Dy³⁺; and/or
the rear earth silicate comprises at least one of Sr₂MgSi₂O₇: Eu²⁺, Dy³⁺, Sr₂MgSi₂O₇: Eu²⁺,Dy³⁺,Nd³⁺, or Sr₂ZnSi₂O₇: Eu²⁺,Dy³⁺.

16. The positive electrode plate according to claim 14, wherein the noctilucent material layer further comprises polyvinylidene difluoride.

17. The positive electrode plate according to claim 16, wherein a mass ratio of the noctilucent material to PVDF is (9 to 19): (1 to 10).

18. A battery cell, wherein the battery cell comprises a negative electrode plate and the positive electrode plate according to claim 1; and the negative electrode plate has a same width as the positive electrode plate.

19. A battery, wherein the battery comprises the positive electrode plate according to claim 1.

20. A battery, wherein the battery comprises the battery cell according to claim 18.
